(19) United States
(12) Patent Application Publication
(10) Pub. No.: US 2006/0120674 A1
(43) Pub. Date: Jun. 8, 2006

(54) Reversible fiber optic module

(76) Inventor: Phillip J. Edwards, San Jose, CA (US)

Correspondence Address: ROBERT A. PARSONS, 4000 N. CENTRAL AVENUE, SUITE 1220, PHOENIX, AZ, 85012, US

(21) Appl. No.: 10/716,727

(22) Filed: Nov. 19, 2003

Related U.S. Application Data
(60) Provisional application No. 60/428,175, filed on Nov. 21, 2002.

(51) Int. Cl. G02B 6/36

(52) U.S. Cl. 385/92

(57) ABSTRACT

An optoelectronic module includes a housing defining first and second elongated generally parallel, adjacent openings, with each opening designed to receive in nesting engagement either an optical transmitter package or an optical receiver package. Each of the first and second openings has optoelectronic circuitry therein for receiving mating optoelectronic circuitry mounted on received optoelectronic packages. A guide is mounted adjacent to each of the first and second openings and defines an upper and a lower channel. The upper and lower channels are constructed and positioned to slideably receive therein a ferrule formed on the received optoelectronic packages.

### CROSS-REFERENCE TO RELATED APPLICATIONS

This application claims the benefit of U.S. Provisional Application No. 60/428,175, filed 21 Nov. 2002.

### FIELD OF THE INVENTION

This invention relates to transceiver packages and, more particularly, to reversible fiber optic interconnections for transceiver packages.

### BACKGROUND OF THE INVENTION

At the present time, standard or common optoelectronic modules include optical-to-electrical and electrical-to-optical, hereinafter optoelectronic, packages. For example, the optoelectronic package can be a receiver, generally including some type of photodiode (e.g. a PIN diode, P/N diode, etc.) and/or the optoelectronic package can be a transmitter, generally including some type of laser, such as a vertical cavity surface emitting laser (VCSEL), an edge emitting laser, cavity surface emitting laser (VCSEL), an edge emitting laser, etc. These optoelectronic packages are generally used in pairs for two-way communication by placing them side-by-side so they can be inserted into the optoelectronic module. Throughout this disclosure, the term “package” is used to denote a complete optoelectronic transmitter, receiver, or some combination of the two that is ready to have optical fibers engaged therein. The term “module” is used to denote a housing, case, or other holder constructed to receive an optoelectronic package plugged or otherwise electrically engaged therein.

One problem with this setup is that the optoelectronic transmitter and receiver packages are not interchangeable because of an asymmetry in their design. For example, in one optoelectronic module, the transmitter would be on the left side while the receiver would be on the right side. In this configuration, it would not be possible to reverse this orientation so that the receiver is positioned on the left side and the transmitter is positioned on the right side. Hence, it would be desirable to provide a common optoelectronic module wherein the transmitter and receiver packages are interchangeable.

It would be highly advantageous, therefore, to remedy the foregoing and other deficiencies inherent in the prior art.

Accordingly, it is an object the present invention to provide new and improved reversible optoelectronic modules, i.e. any package or packages in the modules can be reversed, and reversible fiber optic interconnections for the optoelectronic modules.

Another object of the present invention is to provide new and improved reversible optoelectronic modules with reduced cost and complexity.

Another object of the present invention is to provide new and improved reversible optoelectronic modules including completely reversible optoelectronic transmitters and optoelectronic receivers.

### SUMMARY OF THE INVENTION

Briefly, to achieve the desired objects of the instant invention in accordance with a preferred embodiment thereof, a new and novel optoelectronic module is disclosed. The module includes a housing defining first and second elongated, generally parallel, adjacent openings, each opening designed to receive in nesting engagement one of an optical transmitter package and an optical receiver package. Each of the first and second openings has optoelectronic circuitry therein for receiving mating optoelectronic circuitry mounted on received optoelectronic packages. Each of the first and second openings further defines a first and a second channel, the first and second channels each being constructed and positioned to slideably receive therein a ferrule formed on the received optoelectronic packages.

An optoelectronic transmitter package includes an elongated housing designed to be nestingly engaged in either of the first and second openings and has a ferrule formed along one of an upper and a lower side. Either of the upper and lower channels of the first and second openings is designed to slideably receive the ferrule of the transmitter package therein. An optoelectronic receiver package includes an elongated housing designed to be nestingly engaged in the other of the first and second openings and has a ferrule formed along one of an upper and a lower side. Either of the upper and lower channels of the first and second openings is designed to slideably receive the ferrule of the receiver package therein.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a front view of an optoelectronic module;

FIG. 2 is a front view of an optoelectronic package with side-by-side transmitter and receiver packages;

FIG. 3 is an isometric view of the optoelectronic module and the optoelectronic package in a pre-insertion position;

FIG. 4 is a front view of an optoelectronic module in accordance with the present invention; and

FIG. 5 is an isometric view of the optoelectronic module in accordance with the present invention.

### DETAILED DESCRIPTION OF THE DRAWINGS

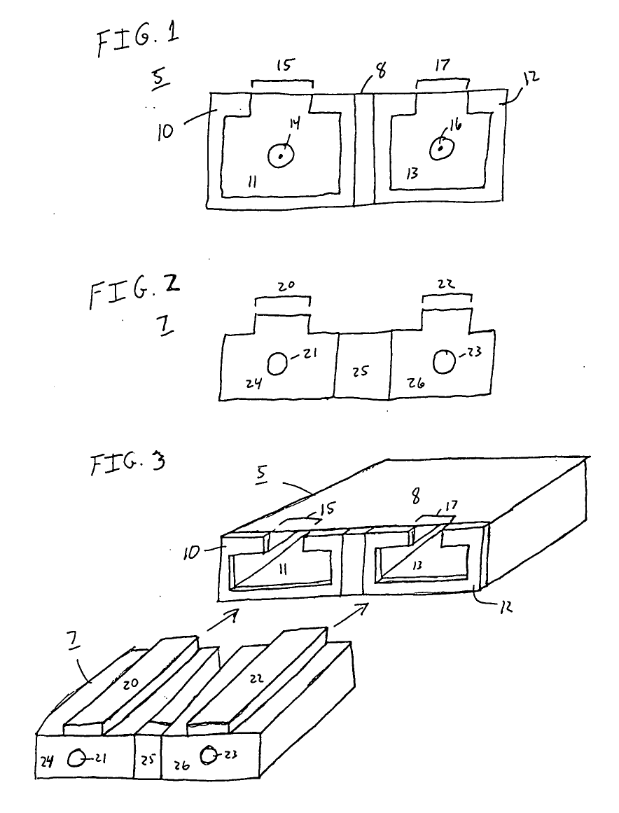

Turn now to FIG. 1 which illustrates an optoelectronic module 5. Here it should be understood that FIGS. 1, 2, and 3 are provided for a basic understanding of the surrounding structures and not as prior art. Optoelectronic module 5 is constructed to define an opening 11 and an opening 13. Opening 11 is defined by a guide 10 with a trench 15 and opening 13 is defined by a guide 12 with a trench 17. It will be understood that guides 10 and 12 are typically formed of a molded plastic fixedly attached to an elongated housing 8 (See FIG. 3). Openings 11 and 13 are specifically designed to receive either an optical-to-electrical or an electrical-to-optical package but not both. In this example, opening 11 is constructed to receive a transmitter package 24 (See FIG. 2) and opening 13 is constructed to receive a receiver package 26 (See FIG. 2).

In module 5, it is desired to couple an optoelectronic circuit 21 (See FIG. 2) within transmitter package 24 with an optoelectronic circuit 14 positioned in opening 11 in module 5. It is also desired to couple an optoelectronic circuit 23 (See FIG. 2) within receiver package 26 with an optoelectronic circuit 16 positioned in opening 13 in module 5. Here it will be understood by those skilled in the art that optoelectronic circuits 21 and 23 are generally optical fibers plugged into transmitter package 24 and receiver package 26 and optoelectronic circuits 14 and 16 are generally some form of electrical circuit designed to convey electrical signals (i.e. data or the like) to and from transmitter package 24 and receiver package 26, respectively.

Turning now to FIG. 2, an optoelectronic package 7 is illustrated. Package 7 includes transmitter package 24 and receiver package 26. Transmitter and receiver packages 24 and 26 are typically physically coupled or joined with a connector 25 for ease of use. Further, transmitter package 24 includes a ridge, rib, or guide, hereinafter ferrule 20, which is designed to be slideably engaged in trench 15 (See FIG. 1), and receiver package 26 includes a ridge, rib, or guide, hereinafter ferrule 22, which is designed to be slideably engaged in trench 17 (See FIG. 2).

Turn now to FIG. 3, which illustrates an exploded view of optoelectronic module 5 and optoelectronic package 7. As shown in FIG. 3, optoelectronic package 7 is capable of nestingly sliding into optoelectronic module 5. As can be seen, transmitter package 24 slides into opening 11 with ferrule 20 fitting into trench 15 and, simultaneously, receiver package 26 slides into opening 13 with ferrule 22 fitting into trench 17.

However, the insertion of optoelectronic package 7 into module 5 is not reversible under this configuration. For example, connector 25 and the orientation of trenches 15 and 17 dictate the orientation of package 7 as described above. However, as described in this disclosure, it is desirable to provide for a reversible module (i.e. a reversible orientation), wherein receiver package 26 can be engaged in either opening 11 or opening 13 and transmitter package 24 can be engaged in either opening 13 or opening 11.

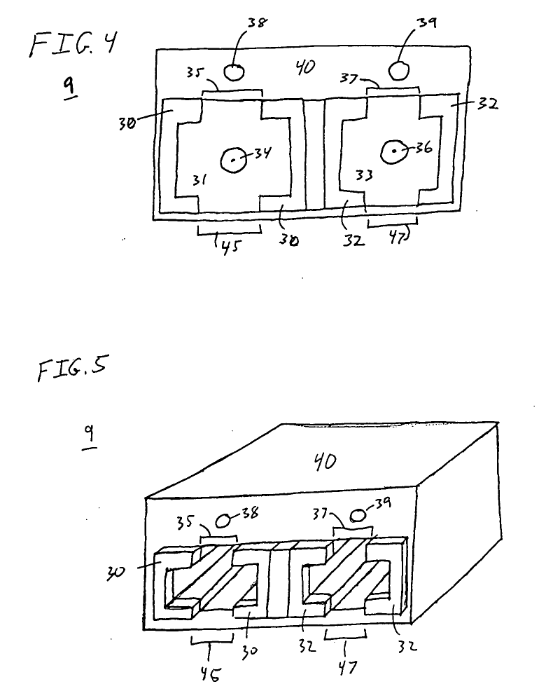

Turn now to FIG. 4 which illustrates a reversible optoelectronic module 9 in accordance with the present invention. Reversible optoelectronic module 9 defines an opening 31 and an adjacent opening 33. Openings 31 and 33 are both specifically designed to receive either optical-to-electrical or electrical-to-optical packages. For example, opening 31 can receive transmitter package 24 (See FIG. 2) and opening 33 can receive receiver package 26 (See FIG. 2) or vice versa.

Opening 31 is further defined by an escutcheon or guide 30 designed to form an upper trench 35 and a lower trench 45. Opening 33 is further defined by an escutcheon or guide 32 designed to form an upper trench 37 and a lower trench 47. It will be understood that guides 30 and 32 are preferably formed of a molded plastic fixedly attached to an elongated housing 40 (also see FIG. 5). It will also be understood by those skilled in the art that the openings 31 and 33 in housing 40 can be constructed to define the upper and lower trenches directly without the use of guides 30 and 32, if desired. Further, while the terms “upper” and “lower” are used herein in conjunction with the figures, they are not intended to act as any limitation on the position of the trenches and it will be understood that the guides and/or trenches could be positioned in a variety of different configurations.

In the preferred embodiment, module 9 includes light indicators 38 and 39 associated with openings 31 and 33, respectively. Indicators 38 and 39 are included to provide an indication that an inserted or nested module, such as module 7, is seated properly. Light indicators 38 and 39 can be, for example, light emitting diodes or the like.

In this embodiment, module 9 is designed to have two modes of operation. In one mode, optoelectronic circuit 21 within transmitter package 24 (see FIG. 2) is coupled with an optoelectronic circuit 34 in opening 31 of module 9. In this same mode, optoelectronic circuit 23 within receiver package 26 (see FIG. 2) is also coupled with an optoelectronic circuit 36 in opening 33 of module 9. This mode is similar to that described in FIGS. 1-3. In this example, transmitter package 24 slides into opening 31 with ferrule 20 being slideably engaged in trench 35 and receiver package 26 slides into opening 33 with ferrule 22 being slideably engaged in trench 37.

In another mode of operation, optoelectronic circuit 21 within transmitter package 24 (see FIG. 2) is coupled with optoelectronic circuit 36. In this same mode, optoelectronic circuit 23 within receiver package 26 (see FIG. 2) is also coupled with optoelectronic circuit 34. In this example, transmitter package 24 slides into opening 33 with ferrule 20 slideably engaged in trench 47 and receiver package 26 slides into opening 31 with ferrule 22 slideably engaged in trench 45.

Thus, the insertion of optoelectronic package 7 into module 9 is easily reversible under this configuration and allows for a duplex form. Also, the optoelectronics associated with each opening is designed to receive either of the transmitter and/or receiver packages. This allows for the installation of interchangeable fiber optic pairs.

Thus, new and improved reversible optoelectronic modules, i.e. any package or packages in the modules can be reversed, is disclosed and reversible fiber optic and electric interconnections for the optoelectronic modules can be provided. The new and improved reversible optoelectronic modules substantially reduced cost and complexity in manufacturing and use because optoelectronic packages, i.e. optoelectronic transmitters and optoelectronic receivers, are completely reversible within the optoelectronic modules.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An optoelectronic module comprising:
a housing defining first and second elongated openings, the openings being generally parallel, adjacent openings and each opening designed to receive in nesting engagement one of an optical transmitter package and an optical receiver package;
each of the first and second openings having optoelectronic circuitry therein for receiving mating optoelectronic circuitry mounted on received optoelectronic packages; and
each of the first and second openings further defining a first and a second channel, the first and second channels each being constructed and positioned to slideably receive therein a ferrule formed on the received optoelectronic packages.

2. An optoelectronic module as claimed in claim 1 further including a guide affixed to the housing adjacent each of the first and second openings, the guide defining the upper and lower channels.

3. An optoelectronic module as claimed in claim 1 wherein the optoelectronic circuitry in each of the first and second openings includes electrical connections for each of an optical transmitter package and an optical receiver package.

4. An optoelectronic module as claimed in claim 1 further including an indicator light associated with each of the first and second openings to indicate that an inserted or nested package is seated properly in the associated opening.

5. An optoelectronic module comprising:
a housing defining first and second elongated openings, the openings being generally parallel, adjacent openings and each opening designed to receive in nesting engagement one of an optical transmitter package and an optical receiver package;
each of the first and second openings having optoelectronic circuitry therein for receiving mating optoelectronic circuitry mounted on received optoelectronic packages; and
a guide mounted adjacent to each of the first and second openings and defining an upper and a lower channel, the upper and lower channels each being constructed and positioned to slideably receive therein a ferrule formed on the received optoelectronic packages.

6. An optoelectronic module as claimed in claim 5 wherein the optoelectronic circuitry in each of the first and second openings includes electrical connections for each of an optical transmitter package and an optical receiver package.

7. An optoelectronic module as claimed in claim 5 further including an indicator light associated with each of the first and second openings to indicate that an inserted or nested package is seated properly in the associated opening.

8. An optoelectronic module comprising:
a housing defining first and second elongated openings, the openings being generally parallel, adjacent openings and each opening designed to receive in nesting engagement one of an optical transmitter package and an optical receiver package;
each of the first and second openings having optoelectronic circuitry therein for receiving mating optoelectronic circuitry mounted on received optoelectronic packages;
a guide mounted adjacent to each of the first and second openings and defining an upper and a lower channel;
an optoelectronic transmitter package including an elongated housing designed to be nestingly engaged in one of the first and second openings and having a ferrule formed along one of an upper and a lower side, the ferrule being designed to be slideably engaged in one of the upper and lower channels of one of the first and second openings; and
an optoelectronic receiver package including an elongated housing designed to be nestingly engaged in another of the first and second openings and having a ferrule formed along one of an upper and a lower side, the ferrule being designed to be slideably engaged in one of the upper and lower channels of the another of the first and second openings.

9. An optoelectronic module as claimed in claim 8 wherein the optoelectronic circuitry in each of the first and second openings includes electrical connections for each of the optical transmitter package and the optical receiver package.

10. An optoelectronic module as claimed in claim 8 further including an indicator light associated with each of the first and second openings to indicate that the one inserted or nested transmitter and receiver package is seated properly in the associated opening.
